(19) United States
(12) Patent Application Publication
(10) Pub. No.: US 2018/0163978 A1
(43) Pub. Date: Jun. 14, 2018

(54) Biosafety Containment System

(71) Applicant: Southern Research Institute, Birmingham, AL (US)

(72) Inventors: Sarah Ann ZIEGLER, Hoover, AL (US); Michelle Wright VALDERAS, Vestavia hills, AL (US)

(21) Appl. No.: 15/377,582

(22) Filed: Dec. 13, 2016

(51) Int. Cl. F24F 3/16; B01D 46/00; F24F 11/02; B01L 1/02; A61G 10/00; A61G 10/02; A61G 11/00

(52) U.S. Cl. CPC F24F 3/161; B01D 46/0039; F24F 11/022; B01L 1/025; A61G 10/005; A61G 10/023; B01L 2200/141; B01D 2279/51; F24F 2003/1614; B01L 2300/123; B01L 2300/06; B01L 2300/0681; A61G 11/009

(57) ABSTRACT

A biosafety containment chamber comprises a rigid frame that supports an enclosure made of a flexible, substantially transparent material, which includes at least top and side surfaces joined to provide a fully enclosed environment. A plurality of glove ports are disposed on the enclosure, each including a flexible glove that enables manipulation of items within the enclosure. The biosafety containment chamber further comprises an air supply system to draw air into the fully enclosed environment through an intake HEPA filter, and an air exhaust system to draw air from the fully enclosed environment into an external environment through an exhaust HEPA filter. The air supply system and the air exhaust system are configurable to maintain a negative pressure in the fully enclosed environment.

### BACKGROUND

The public health and safety community has established standard biosafety levels consisting of combinations of laboratory practices and techniques, safety equipment, and laboratory facilities to ensure safe handling of a wide range of high risk pathogens, specimens, and substances. Within this framework, the Class III biosafety cabinet is designed primarily for work with highly infectious microbiological agents and for the conduct of hazardous operations, and provides the highest attainable level of protection for the environment and personnel. According to NSF 49 standards, a Class III biosafety cabinet requires a stainless steel, gas-tight enclosure with a non-opening, tempered glass view window. Access for passage of materials into the cabinet is through a double-door, pass-through box (e.g., an autoclave) that can be decontaminated between uses. Airflow is maintained by HEPA-filtered supply and exhaust systems that keep the cabinet under negative pressure and ensure the laboratory worker's complete isolation from aerosolized infectious materials. Heavy-duty rubber gloves are attached in a gas-tight manner to ports in the cabinet to allow direct manipulation of the materials isolated inside.

While providing maximum protection, Class III biosafety cabinets are cumbersome, expensive, and inflexible. Such cabinets are bulky, heavy structures that are permanently installed in a fixed location, typically within a laboratory. Such equipment generally cannot be moved or modified without a major renovation of the laboratory facility. Further, Class III biosafety cabinets are impractical and unsuitable for applications that call for a temporary containment system or that require rapid set up in a field environment.

### SUMMARY

Described herein is a biosafety containment system for isolating high risk pathogens, chemicals, and other dangerous substances and aerosols that normally require expensive, permanently-installed Class III biosafety cabinets. While meeting the stringent operating standards required for most bio-containment environments that require a fully sealed enclosure, unlike Class III biosafety cabinets, a containment chamber of the disclosed biosafety containment system has an enclosure comprising a flexible, substantially transparent material, such as clear polyvinyl sheeting, supported by a relatively light-weight, rigid frame comprising, for example, metal rods or the like. By using a flexible, substantially transparent material rather than a stainless steel casing, the containment system can be customized to fit individual needs for work and space areas. This design is comparatively light weight, reconfigurable, and can be semi-permanent, providing much greater flexibility in terms of size, cost, assembly/disassembly, location, and applications relative to a Class III biosafety cabinet.

The containment chamber of the system includes a plurality of glove ports disposed on the enclosure, with each glove port comprising a flexible glove that enables manipulation of items within the enclosure. An air handling system includes an air supply system that draws air into the fully enclosed environment through an intake high-efficiency particulate air (HEPA) filter, and an air exhaust system that draws air from the fully enclosed environment into an external environment through an exhaust HEPA filter such that a negative air pressure is maintained within the enclosure relative to ambient pressure.

The biosafety containment system may also include a decontamination chamber disposed in a region surrounding a sealable access port of the containment chamber. The decontamination chamber includes a second frame, a second enclosure comprising a flexible, substantially transparent material supported by the second frame, an air supply port, an air exhaust port, and a sealable external port. The air handling system is configurable to maintain a negative pressure in the biosafety containment chamber relative to the decontamination chamber when the sealable access port of the containment chamber is open.

The above and still further features and advantages of the described system will become apparent upon consideration of the following definitions, descriptions and descriptive figures of specific embodiments thereof wherein like reference numerals in the various figures are utilized to designate like components. While these descriptions go into specific details, it should be understood that variations may and do exist and would be apparent to those skilled in the art based on the descriptions herein.

### BRIEF DESCRIPTION OF THE DRAWINGS

FIG. 1 is a front perspective view of an example embodiment of a biosafety containment system.

FIG. 2 is a rear perspective view of the example biosafety containment system shown in FIG. 1.

FIG. 3 is a side elevation view of the example biosafety containment system shown in FIG. 1 with the external port of the decontamination chamber partially open.

FIG. 4 is another front perspective view of the example biosafety containment system shown in FIG. 1 with a two-level shelf in the containment chamber.

FIG. 5. is a state diagram showing a sequence of operations for transporting a subject from an external environment to the containment chamber of the biosafety containment system.

FIG. 6. is a table showing control of the air handling system, in particular, the relative flow rates of the air supplies and air exhausts of the containment chamber and decontamination chamber during the different states of the access port and external port.

### DETAILED DESCRIPTION

The biosafety containment system described herein provides a level of protection and safety that normally requires a Class III biosafety cabinet. However, unlike the large, expensive, stainless steel Class III biosafety cabinets that are permanently installed into laboratories and are cumbersome to move and install, the described biosafety containment system is relatively inexpensive and light weight and can be deployed in a much wider variety of environments. The size and spatial configuration of the biosafety containment system can be tailored to the needs of a particular application and setting, and the system can be assembled and disassembled on site to provide a semi-permanent installation.

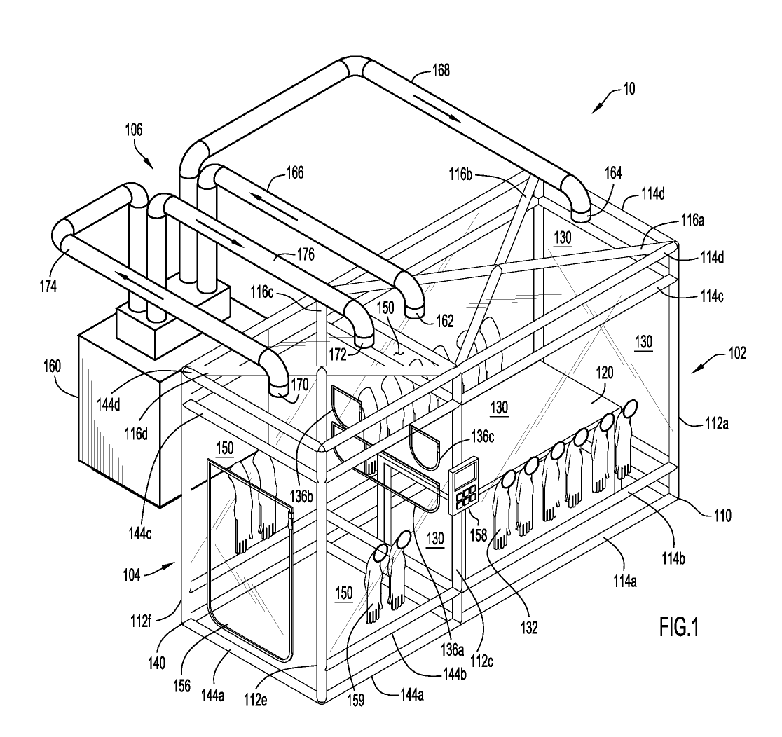

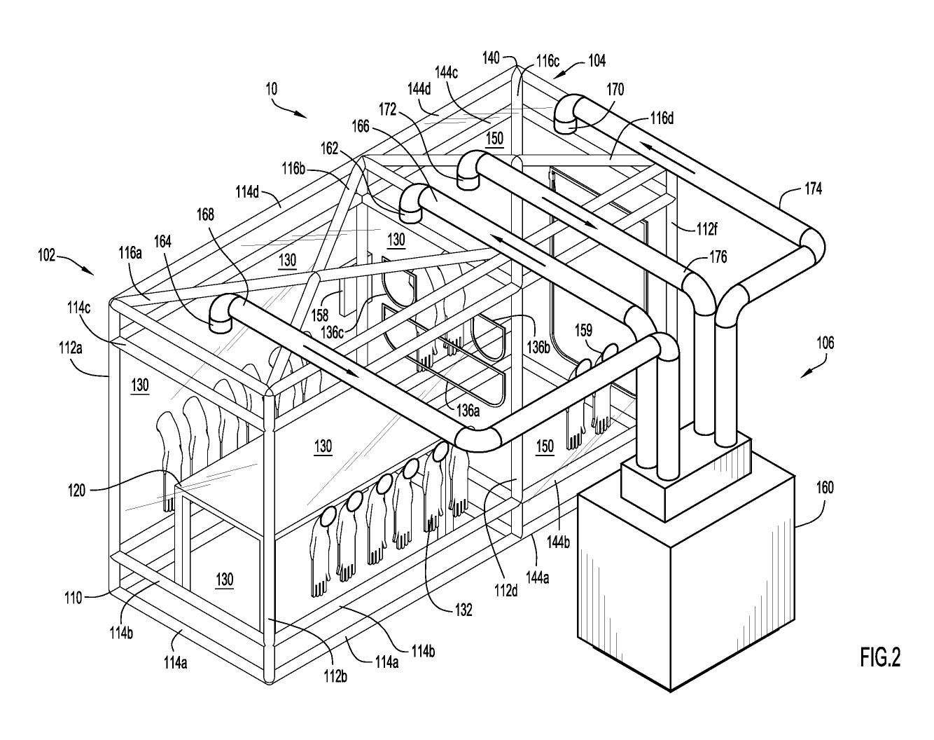

An example embodiment of a biosafety containment system 10 is shown in FIGS. 1-4. FIGS. 1 and 2 respectively show front and rear perspective views of biosafety containment system 10, which includes a containment chamber 102, a decontamination chamber 104, and an air handling system 106. Containment chamber 102 includes a first rigid frame 110 that defines the overall size and shape of containment chamber 102 and provides its structural support. In this example, frame 110 has a generally parallelepiped (cuboid) profile constructed from a set of interconnected rods or pipes. Specifically, frame 110 includes four vertically extending corner rods 112a-112d whose lengths define the height of containment chamber 102, and four horizontally-oriented rectangular rod arrangements 114a-114d whose corners join the four corner rods 112a-112d at different heights and whose dimensions define the length and width of containment chamber 102. Specifically, rod arrangement 114a comprises four constituent rods forming a horizontal rectangle and is connected at its corners to the bottoms of corner rods 112a-112d to form a base. The rods of arrangement 114a can be secured to the floor with fasteners (e.g., bolts, screws, epoxy, etc.) to prevent movement of containment chamber 102. Rectangular rod arrangement 114d is connected at its corners to the tops of corner rods 112a-112d to form a roof frame. For reinforcement, rod arrangement 114b is connected to corner rods 112 a short distance above rod arrangement 114a near the base, and rod arrangement 114c is connected to corner rods 112a-112d a short distance below rod arrangement 114d near the roof. To provide greater stability to the top of frame 110, cross-support rods 116a and 116b extend diagonally between the tops of opposite corner rods (rod 116a extends between rods 112a and 112d, and rod 116b extends between rods 112b and 112c) to form a horizontally-oriented, X-shaped roof support.

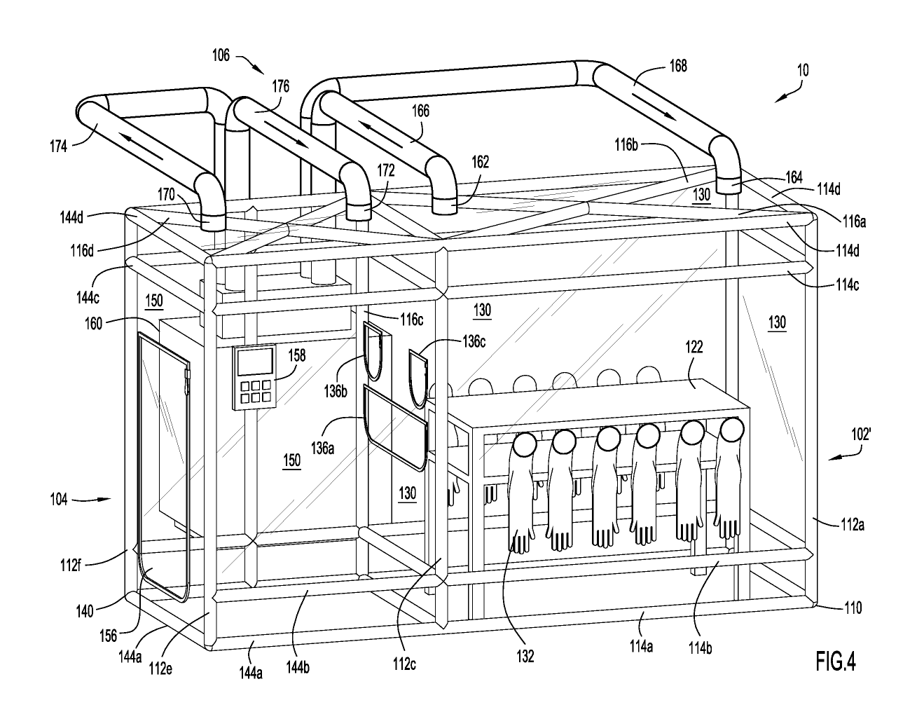

The generally cuboid containment chamber 102 shown in FIGS. 1 and 2 is sufficient large to fully enclose a human subject and is sized to house a stand-alone table 120 having a working surface whose area is approximately two to three square meters. However, this embodiment is just one example of a wide variety of possible configurations. Because the profile of the containment chamber is easily selectable based on the size and arrangement of the constituent rods, the degree of reinforcement, the shape, profile, and overall size of the containment chamber can be customized to the requirements of any particular application (e.g., a floor footprint that is curved, round, T-shaped, etc.). For example, the containment chamber can be larger to enclose multiple human subjects or larger specimens. Conversely, the containment chamber can be smaller where the specimens are smaller laboratory animals or only test tubes and other small laboratory equipment need to be accommodated. FIG. 4 shows a configuration of a containment chamber 102′ that is sized to house a two-level shelf 122 instead of a table. More generally, the containment chamber can be configured to enclose any number of working surfaces and levels.

Referring again to FIGS. 1 and 2, rigid frame 110 of containment chamber 102 supports an enclosure 130 comprising a flexible, substantially transparent material such as a durable, clear poly-vinyl material or other suitable transparent plastic sheeting capable of repeatedly withstanding disinfecting chemicals and gases. In the example shown, enclosure 130 includes four side surfaces or panels and a top surface or panel that are disposed on the outer profile of frame 110. The top and side surfaces are joined to each other and the side surfaces are sealed to the floor (e.g., using a heavy-duty sealant or epoxy glue) to form a fully enclosed and sealed, air-tight environment like that of a Class III biosafety cabinet. In this configuration, the floor underlying the containment chamber must also be air-tight.

According to another option, instead of the side surfaces being sealed to the floor, enclosure 130 further includes a bottom surface or panel that is joined to the side surfaces in an air-tight manner. Preferably, the containment chamber is nevertheless still secured to an underlying surface such as the floor to prevent movement during use. For greater durability, enclosure 130 can be reinforced with thicker material or additional layers of material along edges, corners and other seams and joints where visibility is less critical. According to yet another option, the containment chamber can be configured as a floor-to-ceiling installation with side surfaces that are sealed to both the floor and ceiling in an air-tight manner. In this case, the top surface of the enclosure is omitted, and the ceiling provides an air-tight top surface, and optionally provides ports for the air handling system described below.

As shown in FIGS. 1 and 2, a plurality of glove ports 132 are disposed on side surfaces of enclosure 130 at approximately the height of the working surface of table 120 within containment chamber 102. Each glove port 132 includes a heavy-duty, flexible glove that enables personnel to manipulate items within the enclosure from outside chamber 102 without risk of exposure to dangerous pathogens, chemicals or other substances within chamber 102. In the example shown in FIGS. 1 and 2, six glove ports 132 are arranged in a horizontal line on the front side panel of enclosure 130 and another six glove ports 132 are arranged in a horizontal line on the rear side of enclosure 130, thereby enabling up to six people to access the containment chamber 102 at the same time (up to three people on each side, each using both hands). It will be appreciated that, in general, the number and location of glove ports 132 can vary depending on the size and shape of the containment chamber, the configuration of the working surfaces within the containment chamber, and the particular application for which the containment chamber is being used.

Containment chamber 102 further includes at least one sealable access port sized to permit introduction of a specimen or subject into containment chamber 102. In the example embodiment shown in FIGS. 1 and 2, three access ports 136a, 136b, and 136c (collectively, 136) are depicted for illustrative purposes. Each access port 136 is fully sealable such that, when closed, it maintains the air-tight integrity of containment chamber 102. Any of a variety of sealing mechanisms can be used to keep access ports 136 in a closed, sealed state, including but not limited to: a suitable zipper mechanism; interlocking opposing strips; and/or pressure-sealed, resilient rings. According to another option, access ports 136 can be open and closed electronically by operating a keypad 158 or the like disposed on an exterior surface of biosafety containment system 10, as described in greater detail below. Access port 136a is disposed on the left side surface of enclosure 130 at approximately the height of table 120 and is sized in width and height to permit, when open, passage of a relatively large subject such as a human into containment chamber 102 from decontamination chamber 104. Access ports 136b and 136c are disposed side-by-side on the left side surface of enclosure 130 above access port 136a and so also provide access to containment chamber 102 from decontamination chamber 104. In this case, access ports 136b and 136c are smaller than access port 136a and permit passage of smaller subjects when open. The differing heights of access ports 136a and 136b, 136c may be particularly advantageous for configurations in which a shelf provides working surfaces at corresponding different heights within containment chamber 102, such as in the example in FIG. 4.

Decontamination chamber 104 surrounds the one or more access ports 136 of containment chamber 102 and has a similar construction to containment chamber 102. A second rigid frame 140 defines the overall size and shape of decontamination chamber 104 and provides its structural support. In this example, frame 140 has a generally parallelepiped (cuboid) profile constructed from interconnected rods or pipes and is integrally formed with frame 110 of containment chamber 102 such that the first and second frames 110, 140 constitute an overall frame of biosafety containment system 10. Specifically, frame 140 includes four vertically extending corner rods 112c-112f whose lengths define the height of containment chamber 102. Note that two of the decontamination chamber corner rods, 112c and 112d, also serve as two of the corner rods for containment chamber 102 and bound the side surface on which access ports 136 are located.

Three horizontally-oriented rectangular rod arrangements 144a, 144c, and 144d join at their corners with the four corner rods 112c-112f at different heights and define the length and width dimensions of decontamination chamber 104. Specifically, rod arrangement 144a comprises four constituent rods forming a horizontal rectangle and is connected at its corners to the bottoms of corner rods 112c-112f to form a base. The rods of arrangement 144a can be secured to the floor with fasteners (e.g., bolts, screws, epoxy, etc.) to prevent movement of decontamination chamber 104. Rectangular rod arrangement 144d is connected at its corners to the tops of corner rods 112c-112f to form a roof frame. For reinforcement, a horizontal U-shaped rod arrangement 114b comprises three constituent rods that connect corner rods 112c-112f a short distance above rod arrangement 144a near the base, but does not include a fourth rod extending between corner rods 112e and 112f Finally, rod arrangement 144c is connected to corner rods 112c-112f a short distance below rod arrangement 144d near the roof. To provide greater stability to the top of frame 140, cross-support rods 116c and 116d extend diagonally between the tops of opposite corner rods 112c-112f to form a horizontally-oriented, X-shaped roof support. As with containment chamber frame 110, the particular arrangement of the rods of decontamination chamber frame 140 shown in FIGS. 1-4 is merely one example to illustrate the frame concept, and any of a wide variety of configurations and arrangements are possible.

While it is desirable for the rods of frames 110 and 140 to be relatively light weight, the assembled rods must nevertheless provide sufficient rigidity to ensure the structural integrity of the containment and decontamination chambers under negative pressure and sufficient sturdiness to prevent significant movement of the structure while personnel are manipulating subjects or specimens within containment chamber 102 through the exterior sidewalls or entering or leaving decontamination chamber 104 or handling subjects or specimens therein. Because the rods are disposed within containment chamber 102 and decontamination chamber 104 when deployed, the rods must also be resistant to corrosion and chemicals such as disinfecting chemicals and gases. By way of non-limiting examples, the rods of frames 110, 140 can be heavy-gauge hollow steel or aluminum piping, with a circular or square cross-sectional shape. It will be appreciated that other materials and cross-sectional shapes can be employed. The rods of frames 110, 140 can be connected by any one or a combination of mechanisms, including but not limited to: pipe couplers; interlocking couplings; threaded male-female couplings; overlapping, slide-in end portions held in place by spring-biased pins; welded joints; and fasteners such as screws, bolts, and pins.

Like containment chamber 102, decontamination chamber 104 shown in FIGS. 1 and 2, includes an enclosure 150 comprising a flexible, substantially transparent material such as a durable, clear poly-vinyl material or other suitable transparent plastic sheeting, which is supported by frame 140. In the example shown, enclosure 150 includes four side surfaces or panels and a top surface or panel that are disposed on the outer profile of frame 110. Note that one of the side surfaces of enclosure 150 is also a side surface of enclosure 130, in particular, the side surface on which access ports 136 are disposed. The top and side surfaces are joined to each other, and the side surfaces are sealed to the floor (e.g., using a heavy-duty sealant or epoxy glue) to form a fully enclosed and sealed, air-tight environment like that of a Class III biosafety cabinet. In this configuration, the floor underlying decontamination chamber 104 must also be air-tight.

According to another option, instead of the side surfaces being sealed to the floor, enclosure 150 further includes a bottom surface or panel that is joined to the side surfaces in an air-tight manner. Preferably, the decontamination chamber is nevertheless still secured to an underlying surface such as the floor to prevent movement during use. As with enclosure 130, enclosure 150 can be reinforced with thicker material or additional layers of material along edges, corners and other seams and joints where visibility is less critical. According to yet another option, the decontamination chamber can be configured as a floor-to-ceiling installation with side surfaces that are sealed to both the floor and ceiling in an air-tight manner. In this case, the top surface of the enclosure is omitted, and the ceiling provides an air-tight top surface, and optionally provides ports for the air handling system described below.

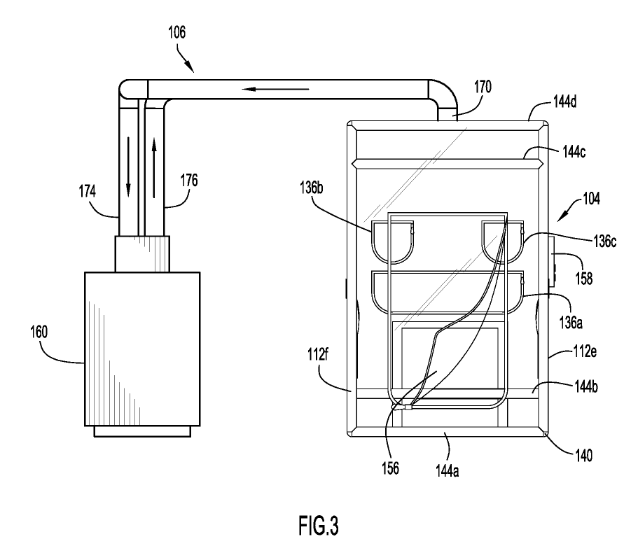

An external port 156 allows ingress into decontamination chamber 104 from a surrounding environment and egress from decontamination chamber 104 into the surrounding environment. The side view of biosafety containment system 10 shown in FIG. 3 depicts external port 156 in a partially open state. As with access ports 136, any of a variety of sealing mechanisms can be used to open and close external port 156, such as a zipper mechanism.

As with containment chamber 102, a plurality of glove ports 159 are disposed on side surfaces of enclosure 150 of decontamination chamber 104. Each glove port 159 includes a heavy-duty, flexible glove that enables personnel to handle and transport items within the enclosure from outside chamber 104 without risk of exposure to dangerous pathogens, chemicals or other substances within chamber 104. In the example shown in FIGS. 1 and 2, two glove ports 159 are arranged on the front side panel of enclosure 150 and another two glove ports 159 are arranged on the rear side of enclosure 150, thereby enabling up to two people to access the decontamination chamber 104 at the same time. It will be appreciated that, in general, the number and location of glove ports 159 can vary depending on the size and shape of the containment chamber. Though personnel do not enter decontamination chamber 104 in many applications and contexts, according to another option, decontamination chamber 104 and external port 156 can be made sufficiently large to allow personnel (at least one human) to enter into and be fully enclosed within the decontamination chamber 104 in order to access the access ports 136 of containment chamber 102. Such a configuration may be appropriate where the biosafety containment system is being used in a quarantine application to isolate a patient infected with a contagious disease.

The containment chamber access ports 136 and the decontamination chamber external port 156 must be interlocked so that only one or the other is open at the same time, as described in greater detail below. Any of a variety of interlock mechanisms can be used to ensure that the access ports and external port are not open at the same time, including sensors and locking devices on each of the ports. According to one example, keypad 158 can be used to electronically manage the interlock system. For example, the operator enters a code to unlock access port 136, which is successful only when the system verifies that the external port 156 is closed (e.g., as detected by a sensor). Similarly, the operator enters a code to unlock external port 156, which is successful only when the system verifies that the access port 136 is closed (e.g., as detected by a sensor).

Because the profile of the decontamination chamber is easily selectable based on the size and arrangement of the constituent rods, the shape, profile, and overall size of the decontamination chamber can be customized to the requirements of any particular application, and the embodiment shown in the figures is just one example of a wide variety of possible configurations. For example, the decontamination chamber can be larger to enclose multiple human subjects, personnel, or larger specimens.

Owing to the containment and decontamination chambers of the biosafety containment system comprising enclosures with a flexible, substantially transparent material such as polyvinyl sheeting supported by rods or piping, items within the containment and decontamination chambers can be viewed from virtually all directions, providing substantially better visibility than a typical Class III biosafety cabinet whose stainless steel shell and glass viewing windows limit visibility.

By constructing the containment and decontamination chambers with a rigid frame of interconnected rods and enclosures comprising a flexible, substantially transparent material, the biosafety containment system constitutes a “semi-permanent” structure or temporary fixture or installation, meaning that it is not as permanent as a Class III biosafety cabinet, which requires a significant renovation of a laboratory to install and remove (e.g., reconfiguring walls, ductwork, etc.). In contrast, the biosafety containment system is designed to be assembled and dismantled with some degree of effort in a relatively short amount of time (hours or days) and is installed at least temporarily in a fixed place (e.g., secured to a floor or other fixed surface). This design makes the biosafety containment system more light weight, inexpensive, and adaptable to a greater range of environments and applications compared to a Class III biosafety cabinet. On the other hand, the described biosafety containment system is not a collapsible or foldable structure and is not highly portable in the sense that it is not well suited to be picked up and moved frequently, though it is more portable than a Class III biosafety cabinet in that it can be easily disassembled, transported, and reassembled and installed in another location.

Air handling system 106 is responsible for ensuring that, relative to an ambient air pressure in the environment surrounding biosafety containment system 10, suitable negative pressures exist in containment chamber 102 and decontamination chamber 104 in the various stages of handling subjects within system 10. Air handling system 106 includes an air supply system configured to draw air into the chambers through an intake HEPA filter, and an air exhaust system configured to draw air from the chambers into an external environment through an exhaust HEPA filter.

In the example embodiment shown in FIGS. 1-4, containment chamber 102 includes a roof-mounted air exhaust port 162 near the end of the containment chamber where access ports 136 are located, and a roof-mounted air supply port 164 near the other end of the containment chamber. Similarly, decontamination chamber 104 includes a roof-mounted air exhaust port 170 near the end of the decontamination chamber where external port 156 is located, and a roof-mounted air supply port 172 near the end of the decontamination chamber where access ports 136 are located. These locations are for illustrative purposes only, and the air supply and exhaust ports of chambers 102 and 104 can be positioned at any suitable locations on the enclosures of the chambers.

Containment chamber air exhaust port 162 is coupled to the air exhaust system, which includes an exhaust pipe 166, an exhaust HEPA filtration system and an exhaust blower unit (e.g., one or more fans). For ease of illustration, the HEPA filtration system and the blower unit of the air exhaust system are represented in the figures by air system housing 160. To meet the safety standards of Class III biosafety cabinets, the air exhaust system is at least double HEPA-filtered (i.e., the exhaust HEPA filtration system includes at least two HEPA filters in series). The air exhaust system vents the HEPA-filtered air drawn from chambers 102 and 104 to an external environment, which can be in the immediate vicinity (e.g., to the room in which system 10 is situated) or to another location (e.g., ducted to outdoors).

Containment chamber air supply port 164 is coupled to the air supply system, which includes a supply pipe 168, an intake HEPA filtration system and an intake blower unit (e.g., one or more fans). As with Class III biosafety cabinets, HEPA filtration on the air supply is desirable in case there is a failure of the air handling system and air pressure becomes temporarily positive, thereby ensuring that all air that leaves the enclosed environment is HEPA filtered. Further, in disease applications, this arrangement prevents introduction via the air supply system of any agents such as contaminants or pathogens other that the one of interest. The air supply system can draw air from the local environment (e.g., from the room in which system 10 is situated) or from another environment (e.g., from outdoors or another room). Here again, for ease of illustration, the intake HEPA filtration system and the intake blower unit of the air supply system are represented in the figures by air system housing 160. However, it will be appreciated that, in general, the air supply and exhaust systems may be housed separately.

Decontamination chamber air exhaust port 170 is coupled to the air exhaust system via an exhaust pipe 174. According to one option, exhaust pipe 174 is coupled to the same exhaust HEPA filtration system (double HEPA filtered) and exhaust blower unit as exhaust port 162 of containment chamber 102. According to another option, air system housing 160 contains two separate HEPA filtration systems and blower units for the two exhaust ports 162 and 170, respectively.

Likewise, decontamination chamber air supply port 172 is coupled to the air supply system via a supply pipe 176. Here again, exhaust pipe 174 can be coupled to the same intake HEPA filtration system and intake blower unit as supply port 164 of containment chamber 102, or two separate HEPA filtration systems and blower units can be used. Where both exhaust ports are coupled to the same exhaust filtration system and blower units and/or both supply ports are coupled to the same intake filtration system and blower units, valves, baffles, or dampers can be provided in one or both of the exhaust paths and/or supply paths to enable air to be drawn from or supply to the two chambers with a different drawing force, which may be desirable under certain operating conditions, as described below.

The blower units of the air supply system and the air exhaust system must be interlocked via a shutoff valve, a switch, or other electronic mechanism such that if either of the systems fails, the other is automatically shut off to ensure that a positive pressure does not develop in either the containment chamber or the decontamination chamber. An alarm system can also be employed to alert personnel of any malfunction or failure of the air handling system.

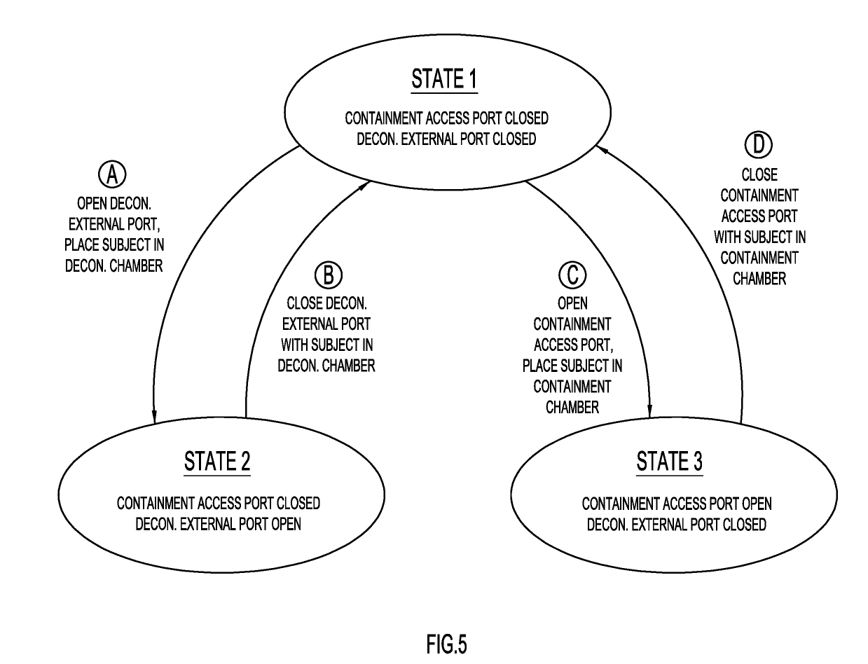

FIG. 5 is a state diagram illustrating the sequence of operations performed to introduce a specimen into containment chamber 102 through decontamination chamber 104. In terms of the open/closed status of containment chamber access port 136 and decontamination chamber external port 156, the system can be configured in essentially three permissible states. In State 1, both containment chamber access port 136 and the decontamination chamber external port 156 are closed (fully sealed). In State 2, containment chamber access port 136 is closed (fully sealed) and decontamination chamber external port 156 is open. In State 3, containment chamber access port 136 is open and decontamination chamber external port 156 is closed (fully sealed).

To introduce a subject into containment chamber 102, in a first step (A), biosafety containment system 10 is transitioned from State 1 (access port closed, external port closed) to State 2 by opening decontamination chamber external port 156 and placing the subject in decontamination chamber 104. In most applications, personnel do not enter decontamination chamber and, once the subject is placed in decontamination chamber 104, it is further handled and transferred via glove ports 159 on the sides of decontamination chamber 104. Optionally, however, where decontamination chamber 104 is suitably dimensioned, a person can enter decontamination chamber 104 along with the subject to facilitate handling and transference of the subject. Once the subject is in decontamination chamber 104, in a second step (B), system 10 is transitioned from State 2 (access port closed, external port open) back to State 1 by closing decontamination chamber external port 156. To ensure containment, decontamination chamber external port 156 is always closed before containment chamber access port 136 is opened, as previously described (i.e., having both decontamination chamber external port 156 and containment chamber access port 136 in an open state simultaneous is not permitted).

To move the subject from decontamination chamber 104 to containment chamber 102, in a next step (C), containment system 10 is transitioned from State 1 to State 3 by opening containment chamber access port 136 and transporting the subject from decontamination chamber 104 to the containment chamber 102 through access port 136. When the containment chamber access port 136 is open, a negative pressure is maintained in the containment chamber relative to the decontamination area to ensure pathogens or contaminants do not enter the decontamination chamber from the containment chamber.

Once the subject is in containment chamber 102, in step (D), containment system 10 is transitioned from State 3 back to State 1 by closing containment chamber access port 136. Here again, to ensure containment, containment chamber access port 136 is closed before decontamination chamber external port 156 is opened. At no point during operation of biosafety containment system 10 are both containment chamber access port 136 and decontamination chamber external port 156 open simultaneously. Although not depicted in FIG. 5, after transporting the subject into containment chamber 102 in step (D), before decontamination chamber external port 156 can be reopened (State 2), a decontamination procedure is generally carried out in decontamination chamber 104 using decontamination chemicals or gases to ensure that any dangerous pathogens or aerosols that may have been present are eliminated.

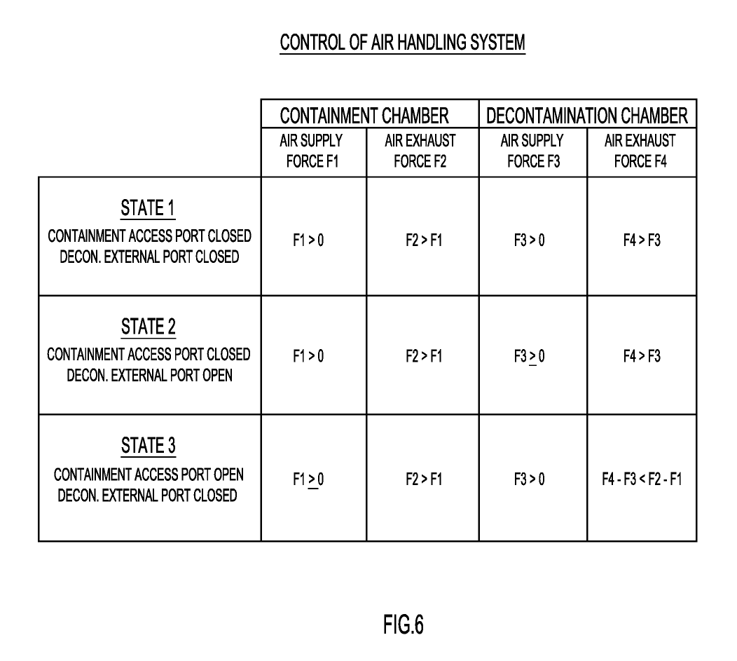

FIG. 6 is a table illustrating control of the air handling system and, in particular, the permissible air flow states of the air supply and air exhaust of the containment chamber and decontamination chamber during the three operational states described in connection with FIG. 5. The containment chamber has an air supply with an incoming airflow force F1 and an air exhaust with an outgoing airflow force F2, while the decontamination chamber has an air supply with an incoming airflow force F3 and an air exhaust with an outgoing airflow force F4. In State 1 (access port closed, external port closed), a negative pressure relative to ambient is maintained in both chambers by making the outgoing airflow forces of the air exhausts greater than the incoming airflow forces of the air supplies (i.e., F1>0, F2>F1 and F3>0, F4>F3). More precisely, this condition is accomplished by the air handling system drawing air from the air exhaust ports of the containment chamber and the decontamination chamber and by supplying air to the air intake ports of the containment chambers with differential force. To maintain a negative pressure in both chambers, the drawing force of the exhaust fan(s) must be greater than that of the intake fan(s). For example, the unloaded air flow rate/capacity of the exhaust fan(s) can be greater than that of the supply fan(s) as result of a faster rotation of the fan blades, the size of the fan blades, the shape and number of the fan blades, the number of fans, or combinations thereof. Starting from an ambient pressure, the greater air flow capacity of the exhaust fan(s) will initially evacuate more air from the chambers than the intake fan(s) supply. Depending on a number of design considerations, including the characteristics and operational setting of the air exhaust fan(s) and the air flow resistance of the air intake path, the air pressure in the chambers is reduced over a period of time from an ambient pressure to a steady state negative pressure relative to ambient pressure. At this point, the pressure difference between the interior of the chamber and the ambient pressure causes air to be drawn into the chamber via the air intake port at the same rate at which air is force out of the chamber by the air exhaust system, such that the incoming and outgoing air flow rates are equalized to maintain a steady state negative pressure.

In State 2 (access port closed, external port open), the air handling in containment chamber can remain the same as in State 1, i.e., a negative pressure relative to ambient is maintained by making the outgoing airflow force of the air exhaust greater than the incoming airflow force of the air supply (i.e., F1>0, F2>F1). In the decontamination chamber, it is also necessary to maintain a negative air pressure relative to the ambient pressure of the surrounding environment. However, because the external port is open, it is not as critical for the air supply of the decontamination chamber to provide a significant incoming airflow force. In fact, to maintain a negative pressure with the external access open, it is desirable to increase the difference between the incoming airflow force F3 and the outgoing airflow force F4, either by deceasing F3 to as low as zero (air supply shut off) or to increase F4, or both (F3≥0, F4>F3). The system can be configured such that the State 2 airflow configuration is automatically triggered upon attempting to open the external port of the decontamination chamber, which is permitted only when the access port of the containment chamber is closed.

In State 3 (access port open, external port closed), two requirements must be met: both chambers must maintain a negative air pressure relative to the ambient air pressure; and the air pressure in the containment chamber must be less (more negative) than the air pressure in the decontamination chamber (F4−F3<F2−F1) to ensure pathogens or contaminants do not enter the decontamination chamber from the containment chamber. With air supplies and air exhausts in both chambers, these conditions can be met in a variety of ways. For example, the decontamination chamber air exhaust can be shut off (F4=0), the containment chamber air supply can be shut off (F1=0), and the airflow force of the containment chamber air exhaust F2 can be set higher than the airflow force of the decontamination chamber air supply F3 (F2>F3). At a minimum the differential between F2 and F1 must result in a more negative pressure than the differential between F4 and F3, and the overall airflow exhaust force must exceed the overall airflow supply force. The system can be configured such that the State 3 airflow configuration is automatically triggered upon attempting to open the access port of the containment chamber, which is permitted only when the external port of the decontamination chamber is closed.

The described biosafety containment system is capable of handling highly infectious regulated material (e.g., risk group 2-4) and is durable to most disinfecting chemicals and gases. For example, this technology can be used to enclose aerosol equipment currently used to dose small animals with high risk pathogens that include select agents in an A/BSL-3 facility. Institutions and organizations can use the described biosafety containment system in any context in which a Class III biosafety cabinet is currently needed, which may include applications like BSL-4 environments. In fact, the flexibility of the described biosafety containment system allows it to be used in a wider variety of applications and settings, while being cheaper and easier to use than current Class III biosafety cabinets. The system can be deployed rapidly in the field for medical treatment and in healthcare settings as a quarantine-like unit for contaminated people, such as a person infected with contagion or contaminated with a dangerous pathogen or chemical (e.g., Ebola or TB responses). The system can also be used to decontaminate soil and rock samples. Another suitable application is in the field of necropsy, wherein the system helps avoid splashes of fluids during an autopsy of an animal or human specimen. Yet another potential application is in the field of clean room applications.

Having described example embodiments of a biosafety containment system, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation.

What is claimed is:

1. A biosafety containment chamber, comprising:
a rigid frame to provide an overall shape for the biosafety containment chamber;
an enclosure supported by the rigid frame and including top and side surfaces joined to provide a fully enclosed environment, the enclosure comprising a flexible, substantially transparent material;
a plurality of glove ports disposed on the enclosure, each glove port comprising a flexible glove that enables manipulation of items within the enclosure;
an air supply system configured to draw air into the fully enclosed environment through an intake high-efficiency particulate air (HEPA) filter; and
an air exhaust system configured to draw air from the fully enclosed environment into an external environment through an exhaust HEPA filter, the air supply system and the air exhaust system being configurable to maintain a negative pressure in the fully enclosed environment.

2. The biosafety containment chamber of claim 1, further comprising a sealable access port sized to permit introduction of a specimen into the biosafety containment chamber.

3. The biosafety containment chamber of claim 2, wherein the access port provides access to the biosafety containment chamber from a decontamination chamber.

4. The biosafety containment chamber of claim 1, wherein the enclosure is sealable to a floor along a bottom of the side surfaces.

5. The biosafety containment chamber of claim 1, wherein the enclosure further comprises a bottom surface joined to the side surfaces.

6. The biosafety containment chamber of claim 1, wherein the flexible, substantially transparent material comprises clear polyvinyl sheeting.

7. The biosafety containment chamber of claim 1, wherein the air supply system and the air exhaust system are interlocked to prevent a positive pressure from occurring in the biosafety containment chamber in response to a failure of the air supply system or the air exhaust system.

8. The biosafety containment chamber of claim 1, wherein the rigid frame comprises a plurality of interconnected rods.

9. The biosafety containment chamber of claim 8, wherein the rods comprise hollow metal piping.

10. The biosafety containment chamber of claim 1, wherein the biosafety containment chamber is sized to house a human subject.

11. A biosafety containment system, comprising:
a containment chamber including: a first frame; a first enclosure comprising a flexible, substantially transparent material supported by the first frame to provide a fully enclosed environment; a plurality of gloves disposed on the enclosure to enable manipulation of items within the enclosure; an air supply port and an air exhaust port; and a sealable access port;
a decontamination chamber disposed in a region surrounding the sealable access port and including: a second frame; a second enclosure comprising a flexible, substantially transparent material supported by the second frame; an air supply port and an air exhaust port; and a sealable external port; and
an air handling system to draw air into the air supply ports of the containment chamber and the decontamination chamber through at least one intake high-efficiency particulate air (HEPA) filter, and to draw air from the air exhaust ports of the containment chamber and the decontamination chamber into an external environment through at least one exhaust HEPA filter, wherein the air handling system is configurable to maintain a negative pressure in the containment chamber relative to the decontamination chamber when the sealable access port of the containment chamber is open.

12. The biosafety containment system of claim 11, wherein the air handling system is configurable to maintain a negative pressure in the containment chamber relative to an ambient pressure.

13. The biosafety containment system of claim 11, wherein the air handling system is configurable to maintain a negative pressure in the decontamination chamber when the sealable external access port is open.

14. The biosafety containment system of claim 11, wherein the first and second frames are connected.

15. The biosafety containment system of claim 11, wherein the first and second enclosures are sealable to a floor and a ceiling.

16. The biosafety containment system of claim 11, wherein the first and second enclosures comprise clear, polyvinyl sheeting.

17. The biosafety containment system of claim 11, wherein the air handling system comprises:
an air supply system to draw air into the air supply ports of the containment chamber and the decontamination chamber;
an air exhaust system to draw air from the air exhaust ports of the containment chamber and the decontamination chamber; and
an interlock between the air supply system and the air exhaust system to prevent a positive pressure from occurring in the containment chamber or the decontamination chamber in response to a failure of the air supply system or the air exhaust system.

18. The biosafety containment system of claim 11, wherein the rigid frame comprises a plurality of interconnected rods.

19. The biosafety containment system of claim 18, wherein the rods comprise hollow metal piping.

20. The biosafety containment system of claim 11, wherein the containment chamber is sized to house a human subject.
